(19) United States
(12) Patent Application Publication
(10) Pub. No.: US 2023/0342216 A1
(43) Pub. Date: Oct. 26, 2023

(54) SYSTEM AND METHOD FOR INFERENCE MODEL GENERALIZATION FOR A DISTRIBUTED ENVIRONMENT

(71) Applicant: Dell Products L.P., Round Rock, TX (US)

(72) Inventors: Ofir Ezrielev, Be'er Sheva (IL); Jehuda Shemer, Kfar Saba (IL)

(21) Appl. No.: 17/726,253

(22) Filed: Apr. 21, 2022

(51) Int. Cl. G06F 9/50; G06N 5/04

(52) U.S. Cl. CPC G06F 9/5072; G06F 9/5077; G06N 5/04

(57) ABSTRACT

Methods and systems for managing generalization of inference models throughout a distributed environment are disclosed. To manage generalization of inference models, a system may include a data aggregator and one or more data collectors. The data aggregator may obtain a similarity graph in order to determine the relationship between data obtained by one or more data collectors. The similarity graph may be used to obtain grouping for the data collectors. The data aggregator may train inference models to facilitate data collection by the data collectors included in the grouping.

### FIELD

Embodiments disclosed herein relate generally to data collection. More particularly, embodiments disclosed herein relate to systems and methods to limit the transmission of data over a communication system during data collection.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a block diagram illustrating a data aggregator in accordance with an embodiment.

FIG. 3A shows a flow diagram illustrating a method of selecting inference models for groupings of data collectors in accordance with an embodiment.

FIG. 3B shows a flow diagram illustrating a method of updating inference models for groupings of data collectors in accordance with an embodiment.

FIGS. 4A-4E show block diagrams illustrating a system and/or similarity graphs generated by the system in accordance with an embodiment over time.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing the distribution of inference models throughout a distributed environment. To manage the distribution of inference models, the system may include a data aggregator and one or more data collectors. The data aggregator may utilize training data from the one or more data collectors to obtain a similarity graph, the similarity graph being obtained by feeding the training data from one or more data collectors into a similarity algorithm. The similarity graph may include representations of the one or more data collectors as nodes and the similarity algorithm may provide some similarity measure as a representation of the relationship between the nodes.

The similarity measure between any two nodes may be represented by a weighted edge on the similarity graph, the weight of the edge corresponding to the degree of similarity between the data collected by the two nodes. A higher weight may indicate a larger degree of similarity between the data collected by the two nodes, while a lower weight may indicate a smaller degree of similarity between the data collected by the two nodes.

Groupings of nodes may be determined by an analysis of the weighted edges on the similarity graph. Methods may be utilized to determine whether to discard an edge, including the use of a threshold for edge weights. Other methods may be utilized, including discarding edges in order to maintain a maximum and/or minimum number of nodes in a particular grouping (and/or other reason). By eliminating some edges, nodes connected by the retained edges may be associated with one grouping of nodes on the similarity graph.

The data aggregator may train inference models utilizing training data obtained from the nodes associated with a particular grouping of nodes, rather than training a unique inference model based on data obtained from each individual node. Therefore, one inference model may be utilized to predict data based on measurements performed by a grouping of nodes and facilitate data collection by the grouping of nodes.

By generalizing the training of inference models, the data aggregator may host and operate fewer inference models and, therefore, reduce the computing resources required for operation. This may serve as a particular advantage for large distributed environments (e.g., those made up of millions of nodes or more) where training individual inference models may require excessive computational overhead and utilizing one inference model may provide inaccurate predictions across the distributed environment. An inference model trained to predict measurements performed by a grouping of nodes may provide more accurate predictions than an inference model trained across multiple groupings of nodes. In addition, by utilizing one inference model to facilitate data collection by a grouping of nodes, the amount of data transmitted over a communication network may be reduced during the training and re-training of inference models. Consequently, communication bandwidth and power consumption may also be minimized throughout the distributed environment.

In an embodiment, a method for managing data collection in a distributed environment where data is collected in a data aggregator of the distributed environment and from at least a data collector operably connected to the data aggregator via a communication system is provided.

The method may include obtaining, by the data aggregator, a similarity graph, the similarity graph comprising: nodes based on data collected from sources throughout the distributed environment and representing the sources, and a relationship between a portion of the nodes, the relationship being implemented with an edge connecting a portion of the nodes; determining, by the data aggregator, groupings of the nodes based on the similarity between the nodes; obtaining, by the data aggregator, an inference model for each of the groupings; collecting data from the data sources utilizing the inference models, the inference models being used to reduce a quantity of data transmitted for the data collection.

The method may also include making a determination that the relationship between the nodes falls below a threshold; and based on the determination: discarding the edge.

Discarding the edge indicates that the portion of the nodes collect dissimilar data.

The method may also include making a determination that the relationship between the nodes is within a threshold; and based on the determination: retaining the edge between the portion of the nodes.

Retaining the edge indicates that the portion of the nodes collect similar data.

The method may also include making a determination, based on the updated relationship, that the groupings of the nodes has changed; and based on that determination: selecting an inference model for each of the groupings based on the changed groupings, or obtaining a new inference model for at least one of the groupings using a portion of the collected data associated with the respective grouping.

The method may also include making a determination, based on the updated relationship, that the grouping of nodes has not changed; and based on that determination: continuing the data collection from the data sources utilizing the inference models.

Collecting data from the data sources utilizing the inference models may also include for a portion of the data sources that are members of a group of the groups, use an inference model of the inference models associated with the group to collect the portion of the data from the portion of the data sources.

The similarity between any two nodes of the nodes is based on a similarity measure of data collected by the data sources associated with the two nodes and the method of determining the similarity measure comprises one selected from a group consisting of determining cosine similarity between nodes, performing a kernel method to determine clusters of nodes, and determining similarity of an aggregated statistic associated with the nodes.

A non-transitory media may include instructions that when executed by a processor cause the method to be performed.

A data processing system may include the non-transitory media and a processor, and may perform the method when the computer instructions are executed by the process.

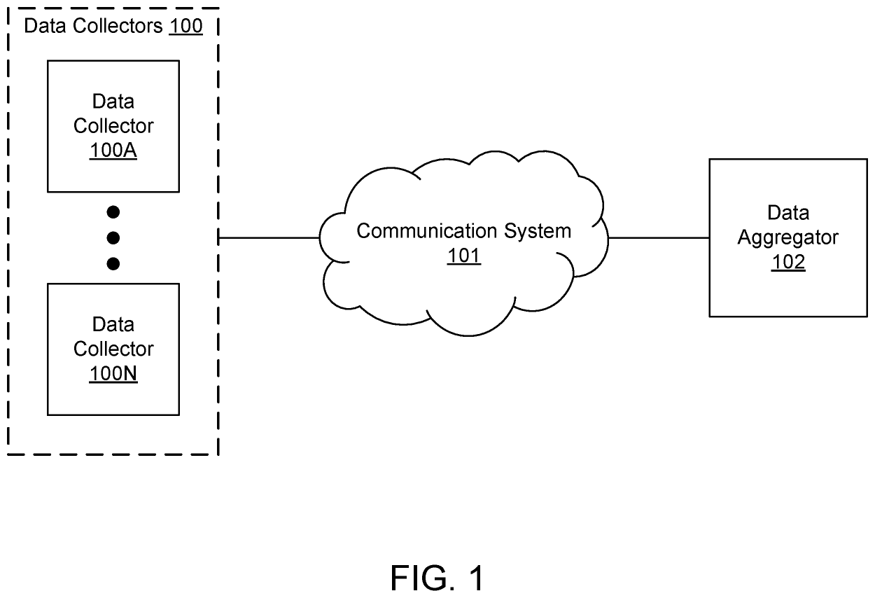

Turning to FIG. 1, a block diagram illustrating a system in accordance with an embodiment is shown. The system shown in FIG. 1 may provide computer-implemented services that may utilize data aggregated from various sources throughout a distributed environment.

The system may include data aggregator 102. Data aggregator 102 may provide all, or a portion, of the computer-implemented services. For example, data aggregator 102 may provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed environment.

For example, data aggregator 102 may be used as part of a control system in which data that may be obtained by data collectors 100 is used to make control decisions. Data such as temperatures, pressures, etc. may be collected by data collectors 100 and aggregated by data aggregator 102. Data aggregator 102 may make control decisions for systems using the aggregated data. In an industrial environment, for example, data aggregator 102 may decide when to open and/or close valves using the aggregated data. Data aggregator 102 may be utilized in other types of environments without departing from embodiments disclosed herein.

To facilitate data collection, the system may include one or more data collectors 100. Data collectors 100 may include any number of data collectors (e.g., 100A-100N). For example, data collectors 100 may include one data collector (e.g., 100A) or multiple data collectors (e.g., 100A-100N) that may independently and/or cooperatively provide data collection services.

For example, all, or a portion, of data collectors 100 may provide data collection services to users and/or other computing devices operably connected to data collectors 100. The data collection services may include any type and quantity of services including, for example, temperature data collection, pH data collection, humidity data collection, etc. Different systems may provide similar and/or different data collection services.

To aggregate data from data collectors 100, data aggregator 102 and/or data collectors 100 may host inference models to facilitate a reduction in the quantity of data transmitted over communication system 101 during data collection. For example, the inference models may be used to allow data aggregator 102 to predict data that will likely be obtained by data collectors 100, thereby entirely or partially eliminating the need for data collectors 100 to provide data aggregator 102 with copies of all obtained data for data aggregator 102 to have access to such data.

Data collectors 100 may be part of the same distributed environment while being positioned in locations with different ambient conditions. In order to facilitate data collection in these disparate ambient environments, data aggregator 102 may host multiple inference models. Hosting and operating large quantities of inference models may have undesirable effects on data aggregator 102 and/or communication system 101. For example, hosting and operating multiple inference models may require increased computational overhead for data aggregator 102. In addition, operating a unique inference model for each of data collectors 100 may result in increased network transmissions during training and re-training of models, which may increase network bandwidth and power consumption throughout the distributed environment.

In general, embodiments disclosed herein may provide methods, systems, and/or devices for managing inference model distribution in a distributed environment. To manage inference model distribution, a system in accordance with an embodiment may generalize inference model distribution throughout a distributed environment by obtaining groupings of data collectors. The groupings of data collectors may be data collectors positioned in similar ambient environments, data collectors that collect similar ranges of data, etc. In order to generalize the distribution of inference models, at least a portion of the data collectors in a grouping may utilize the same inference model to facilitate data collection. By doing so, computational resources may be conserved and network transmissions may be limited.

To provide its functionality, data aggregator 102 may (i) obtain a similarity graph by obtaining data from multiple nodes (e.g., data collectors) and determine the relationship between the data collected from the nodes, (ii) establish groupings of data based on relationships between the nodes, (iii) train inference models using all (or a portion) of the data associated with a grouping of nodes, (iv) utilize the trained inference model to facilitate data collection for each of the nodes associated with the grouping of nodes and (v) update the relationships upon obtaining additional data from the nodes. By doing so, inference models may be utilized to facilitate data collection across multiple nodes operating similarly and, therefore, may provide more accurate predictions than utilizing one inference model for all nodes in a distributed environment. In contrast, training one inference model for each node may require a higher (and/or potentially unfeasible) amount of computational overhead. Consequently, training inference models to predict measurements by groupings of nodes may allow data aggregator 102 to host and operate fewer inference models and, therefore, consume fewer computing resources during operation.

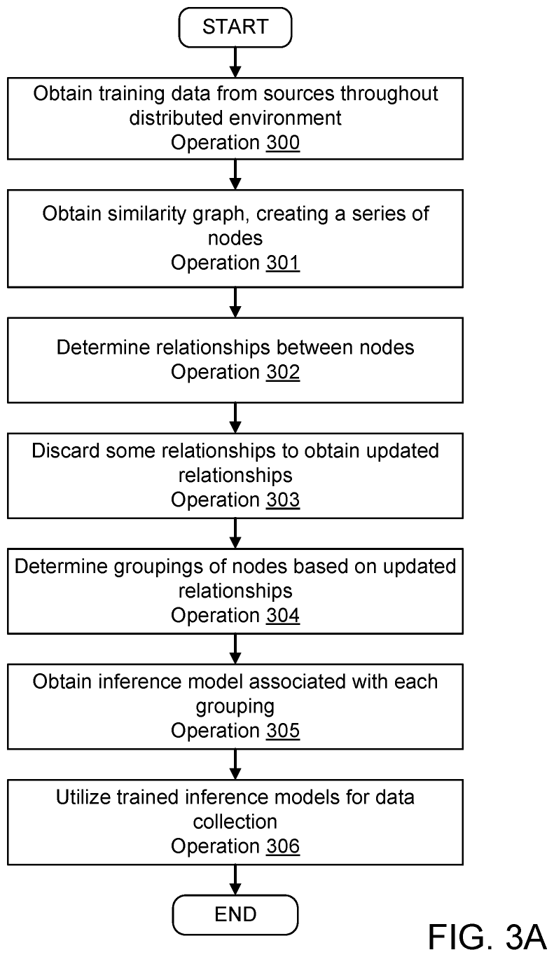

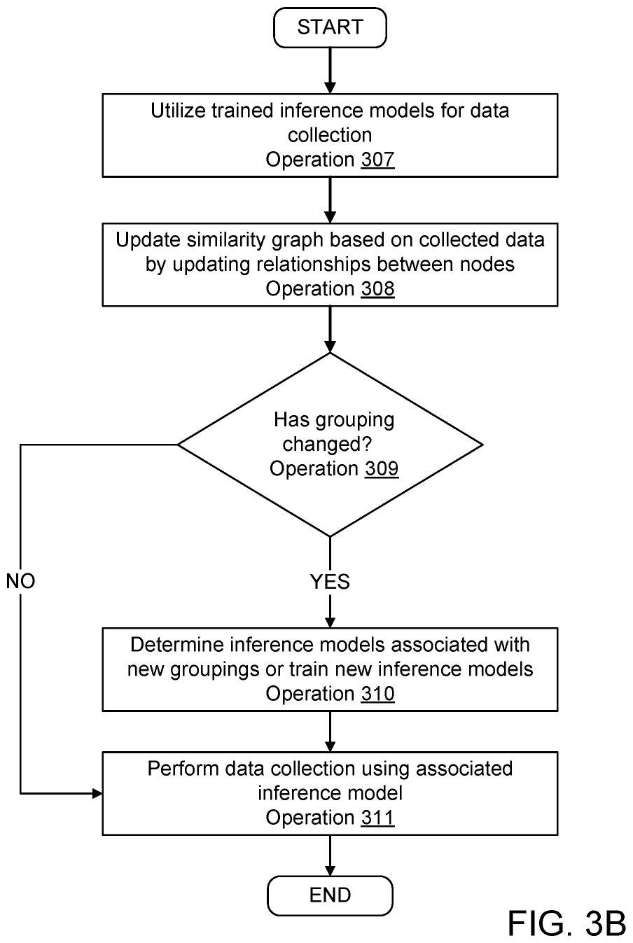

When performing its functionality, data aggregator 102 may perform all, or a portion, of the methods and/or actions shown in FIGS. 3A-3B.

Trained inference models may be utilized to facilitate the reduction of data transmissions during data collection. In order to reduce data transmissions during data collection, inference models may be hosted and operated by data aggregator 102 and/or data collectors 100 and trained to predict data based on measurements performed by data collectors 100.

In a first scenario, data collectors 100 may obtain and transmit a data statistic (e.g., a reduced-size representation of data) to data aggregator 102. Data aggregator 102 may host an inference model trained to predict data based on measurements performed by data collectors 100 and may obtain a complementary data statistic based on the inferences. If the data statistic matches the complementary data statistic within some threshold, the inference model may be determined accurate and the inferences may be stored as aggregated data. By doing so, full data sets may not be obtained by data aggregator 102 from data collectors 100 and, therefore, data transmissions may be reduced across communication system 101.

In a second scenario, identical copies of a trained twin inference model may be hosted by data aggregator 102 and data collectors 100 and, therefore, may generate identical inferences. Data collectors 100 may reduce network transmissions by generating a difference based on: (i) data based on measurements performed by the data collectors and (ii) inferences generated by the copy of the twin inference model hosted by the data collectors. Data aggregator 102 may obtain the difference from data collectors 100 and may reconstruct data based on: (i) the difference and (ii) inferences generated by the copy of the twin inference model hosted by data aggregator 102. Consequently, full data sets may not be transmitted over communication system 101 and network bandwidth consumption may be reduced. Inference models may be utilized to facilitate the reduction of data transmissions during data collection via other methods without departing from embodiments disclosed herein.

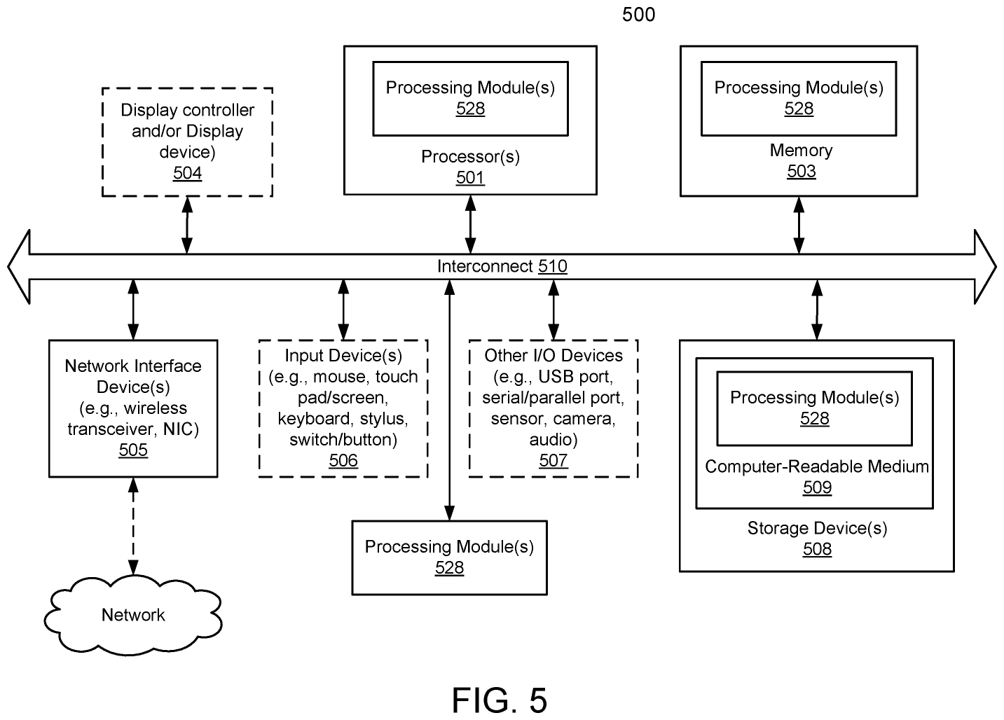

Data collectors 100 and/or data aggregator 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data collectors 100 are implemented using an internet of things (IoT) device, which may include a computing device. The IoT device may operate in accordance with a communication model and/or management model known to the data aggregator 102, other data collectors, and/or other devices.

Any of the components illustrated in FIG. 1 may be operably connected to each other (and/or components not illustrated) with a communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

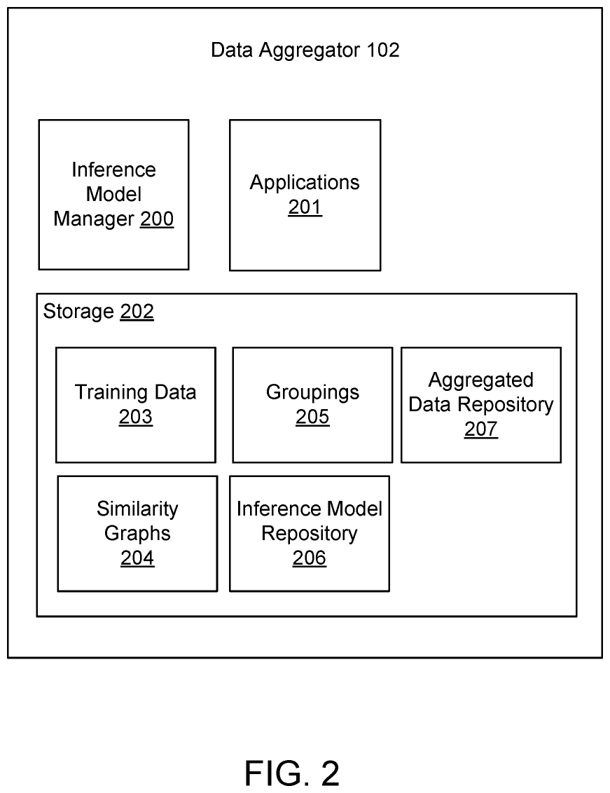

As discussed above, the system of FIG. 1 may include one or more data aggregators. Turning to FIG. 2, a diagram of data aggregator 102 in accordance with an embodiment is shown. Data aggregator 102 may provide computer-implemented services that utilize data aggregated from various sources within a distributed environment. In order to do so, data aggregator 102 may obtain groupings of data collectors via a similarity graph and train inference models to predict data from groupings of data collectors rather than from individual data collectors. By doing so, inference models may be generalized for use by one or more data collectors within a grouping of data collectors. Consequently, the computational overhead required by data aggregator 102 to host and operate inference models may be reduced. To provide its functionality, data aggregator 102 may include inference model manager 200, applications 201, and/or storage 202. Each of these components is discussed below.

Inference model manager 200 may (e.g., to provide all, or a portion, of the computer-implemented services) (i) obtain training data from sources (e.g., data collectors 100) throughout a distributed environment, (ii) obtain a similarity graph, by creating a node for each source, (iii) determine relationships between nodes by obtaining a similarity measure between the nodes, and discarding some relationships below a threshold to obtain updated relationships between nodes, (iv) determine groupings of nodes based on the updated relationships between the nodes, (v) obtain one or more inference models based on the training data associated with each grouping of nodes, (vi) utilize the trained inference models to facilitate the reduction of data transmissions during data collection from the data collectors, and (vii) update similarity graphs, groupings, and inference models associated with data collectors based on data collected from data collectors.

In an embodiment, inference model manager 200 may obtain training data sets from sources (e.g., data collectors) throughout a distributed environment. Training data sets may include any quantity and type of data. For example, training data sets may include a series of measurements representing an ambient environment (e.g., temperature data, humidity data, pH data).

In an embodiment, the data collectors may be positioned in disparate ambient conditions and, therefore, may obtain a variety of types and/or ranges of data. For example, a first data collector may be a temperature sensor positioned in a medical storage facility. In this facility, temperature control may be required in the range of −45° C. to −35° C. and the training data set may include the following temperature measurements obtained over the course of one hour: T₁=−40.5° C., T₂=−38.5° C., T₃=−36.0° C., T₄=−41.0° C., T₅=−37.0° C. A second data collector may be a temperature sensor positioned outdoors to monitor ambient temperatures in the range of 25° C. to 40° C. and the training data set may include the following temperature measurements over the course of one hour: T₁=32.0° C., T₂=32.5° C., T₃=32.0° C., T₄=34.5° C., T₅=36.0° C.

In an embodiment, inference model manager 200 may obtain a similarity graph, creating a node for each source. The training data associated with each node may be utilized to determine similarity between the nodes as described below.

In an embodiment, inference model manager 200 may determine relationships between nodes by obtaining a similarity measure between the nodes. In order to obtain similarity measures between nodes, an operation may be performed on the training data sets obtained from each node. The operation may consist of, for example, performing a kernel method to determine clusters of nodes, determining cosine similarity between nodes, determining Euclidian distance between nodes, determining Pearson coefficient (and/or other correlation functions) between nodes, and/or determining similarity of an aggregated statistic (e.g., an average) associated with each node. Other methods of determining similarity measures may be used without departing from embodiments disclosed herein.

In an embodiment, the similarity measure between nodes of the similarity graph may be represented on the similarity graph by a weighted edge between nodes. Each node on the similarity graph may be connected by an edge, each edge being weighted based on the similarity measure determined by one of the operations described above. For example, each edge may be weighted on a scale of 0 to 1, with 0 being the most dissimilar nodes and 1 being the most similar nodes. Edges may be weighted using other criteria without departing from embodiments disclosed herein.

For example, three nodes on a similarity graph may represent three temperature sensors in different locations throughout a distributed environment. Continuing with the above example, the first temperature sensor may obtain the following training data set: T₁=−40.5° C., T₂=−38.5° C., T₃=−36.0° C., T₄=−41.0° C., T₅=−37.0° C. and a second temperature sensor may obtain the following training data set: T₁=32.0° C., T₂=32.5° C., T₃=32.0° C., T₄=34.5° C., T₅=36.0° C. A third temperature sensor may obtain the following training data set: T₁=−42.5° C., T₂=−40.5° C., T₃=−40.0° C., T₄=−41.0° C., T₅=−42.5° C.

In order to determine the similarity measure between each of the three nodes, an average temperature value may be obtained for each node. The average temperature value for the first temperature sensor may be −38.6° C., the average temperature value for the second temperature sensor may be 33.4° C., and the average temperature value for the third temperature sensor may be −41.5° C. A weighted edge may be established between each of the three nodes, the weight representing the similarity of the data on a scale of 0-1. The weight of the edge between the first and second nodes may be 0.08, the weight between the first and third nodes may be 0.90, and the weight between the second and third nodes may be 0.05.

In an embodiment, inference model manager 200 may discard some relationships below a threshold to obtain updated relationships between nodes. The threshold may be any static or dynamic threshold, may be set by a user, and/or may be obtained from another entity through a communication system (e.g., communication system 101). For example, the threshold may be a similarity measure of 0.75 on a scale of 0-1. Therefore, any edge between nodes with a similarity measure below 0.75 may be discarded and any edge between nodes with a similarity measure of 0.75 or above may be retained.

Continuing with the above example, the similarity measure (e.g., weight) of the edge between the first and second nodes may be 0.08, the weight between the first and third nodes may be 0.90, and the weight between the second and third nodes may be 0.05. Therefore, the edge between the first and third nodes may be retained, while the others may be discarded. By doing so, inference model manager 200 may determine which data collectors collect similar types and/or ranges of data (e.g., similar or different data distributions) and generalize methods of data collection from those data collectors as described below.

In a further example, the threshold may be set dynamically until all, or a portion, of groupings include a maximum and/or minimum number of members. For example, if each grouping is to include no more than 10 members, a threshold is set to 0.8, but a grouping includes 14 members, then the threshold may be increased to 0.9 which may result in some relationships being discarded thereby decreasing the membership in the grouping. The members of each grouping may be determined, for example, by performing graph traversal or other methods for analyzing the relationships present in a graph data structure.

In an embodiment, relationships are discarded for other reasons (in addition to or in place of discarding based on thresholds). For example, to efficiently prune a similarity graph to establish groupings, only the relationships of highest similarity (or some number of relationships of highest similarity) for each node may be retained, and lower similarity relationships for each node may be removed (e.g., after all are added).

In an embodiment, inference model manager 200 may determine groupings of nodes based on the updated relationships between the nodes. A grouping may include of one or more nodes with retained edges between the one or more nodes. The grouping may represent a group of one or more data collectors that, based on historical data, are obtaining similar types and/or ranges of data (e.g., collect data having similar distributions. Continuing with the above example, a grouping may be established to include the first and third nodes. A separate grouping may include the second node. These groupings may be utilized by inference model manager 200 to train generalized inference models as described below.

In an embodiment, inference model manager 200 may obtain one or more inference models based on the training data associated with each grouping of nodes. Each grouping of nodes may include one or more data collectors. Therefore, inference model manager 200 may obtain generalized inference models to be used by groupings of data collectors.

In one scenario, inference model manager 200 may obtain one or more inference models from some entity through a communication system (e.g., communication system 101). In another scenario, one or more inference models may be generated using training data. In the second scenario, training data may be fed into one or more predictive algorithms including, but not limited to, artificial neural networks, decision trees, support-vector machines, regression analysis, Bayesian networks, and/or genetic algorithms to generate one or more inference models. The inference models may be generated via other methods without departing from embodiments disclosed herein.

Continuing with the above example, inference model manager 200 may train one inference model using the training data sets from both the first and third nodes. Inference model manager 200 may train a second inference model using training data from the second node. By doing so, one inference model may be implemented to facilitate data collection by the first and third nodes and a second inference model may be implemented to facilitate data collection by the second node. By implementing inference models for similar groupings of data collectors 100, data aggregator 102 may host and operate fewer inference models during data collection as described below.

In an embodiment, inference model manager 200 may utilize the trained inference models to facilitate the reduction of data transmissions during data collection. Inference models may allow data aggregator 102 to behave as though it has access to data based on measurements performed by data collectors 100 without data collectors 100 providing full or partial data sets to data aggregator 102. Refer to FIG. 1 for additional details regarding the use of inference models to reduce data transmissions during data collection. By generalizing inference models to operate across a grouping of nodes, data aggregator 102 may be required to host and operate fewer inference models and, therefore, may consume fewer computing resources during operation.

In an embodiment, inference model manager 200 may update similarity graphs, groupings, and/or inference models associated with data collectors based on data collected from data collectors. Data collected from various sources may be continuously or incrementally used to update the data associated with each node on the similarity graph. When data associated with a node is updated, inference model manager 200 may determine if the grouping associated with the node has changed. If the grouping has changed, inference model manager 200 may determine a new grouping and, therefore, a new inference model to facilitate data collection by the node. If the grouping has not changed, data collection may continue utilizing the current inference model.

Applications 201 may consume data from aggregated data repository 207 to provide computer-implemented services to users of data aggregator 102 and/or other computing devices operably connected to data aggregator 102. The computer-implemented services may include any type and quantity of services which may utilize, at least in part, data aggregated from a variety of sources (e.g., data collectors 100) within a distributed environment.

For example, applications 201 may use the aggregated data to modify industrial manufacturing processes; to sound alerts for undesired operation of systems, locations of persons in an environment; and/or for any other type of purpose. Consequently, applications 201 may perform various actions (e.g., action sets) based on the data in aggregated data repository 207.

In an embodiment, one or more of inference model manager 200 and applications 201 is implemented using a hardware device including circuitry. The hardware device may be, for example, a digital signal processor, a field programmable gate array, or an application specific integrated circuit. The circuitry may be adapted to cause the hardware device to perform the functionality of inference model manager 200 and/or applications 201. One or more of inference model manager 200 and applications 201 may be implemented using other types of hardware devices without departing from embodiments disclosed herein.

In an embodiment, one or more of inference model manager 200 and applications 201 is implemented using a processor adapted to execute computing code stored on a persistent storage that when executed by the processor performs the functionality of inference model manager 200 and/or applications 201 discussed throughout this application. The processor may be a hardware processor including circuitry such as, for example, a central processing unit or a microcontroller. The processor may be other types of hardware devices for processing digital information without departing from embodiments disclosed herein.

When providing its functionality, inference model manager 200 and/or applications 201 may perform all, or a portion, of the operations and/or actions discussed with respect to FIGS. 3A-3B.

When providing its functionality, inference model manager 200 and/or applications 201 may store data and use data stored in storage 202

In an embodiment, storage 202 is implemented using physical devices that provide data storage services (e.g., storing data and providing copies of previously stored data). The devices that provide data storage services may include hardware devices and/or logical devices. For example, storage 202 may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage 202 may include a memory device (e.g., a dual in line memory device) in which data is stored and from which copies of previously stored data are provided. In another example, storage 202 may include a persistent storage device (e.g., a solid-state disk drive) in which data is stored and from which copies of previously stored data is provided. In a still further example, storage 202 may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage 202 may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

Storage 202 may store data structures including, for example, training data 203, similarity graphs 204, groupings 205, inference model repository 206, and aggregated data repository 207. Any of these data structures may be usable by components of the system in FIG. 1. Any of these data structures may be implemented using, for example, lists, tables, databases, linked lists, and/or other type of data structures. Any of the data structures may be shared, spanned across multiple devices, and may be maintained and used by any number of entities. Additionally, while illustrated as including a limited amount of specific data, any of these data structures may include additional, less, and/or different data without departing from embodiments disclosed herein. Each of these data structures is discussed below.

In an embodiment, training data 203 may include training data usable to train a machine learning model (and/or other types of inference-generation models). Training data 203 may be obtained from various sources throughout a distributed environment (e.g., from data collectors 100) and may include (all of, or a portion thereof) a series of measurements representing an ambient environment (e.g., a characteristic thereof) and/or other types of measurements.

For example, training data 203 may include a set of temperature measurements taken at different times in an industrial environment by one or more temperature sensors. Temperature sensors may collect a set of temperature measurements at different times over any period of time. For example, one temperature sensor may record the following data over the course of one hour: T₁=36.5° C., T₂=35.0° C., T₃=35.5° C., T₄=35.0° C., T₅=36.0° C. These temperature measurements may be temporarily or permanently stored by the temperature sensor and transmitted to a central temperature control system when requested for purposes of obtaining a similarity graph, training a machine-learning model to predict future temperature measurements in the same environment, etc.

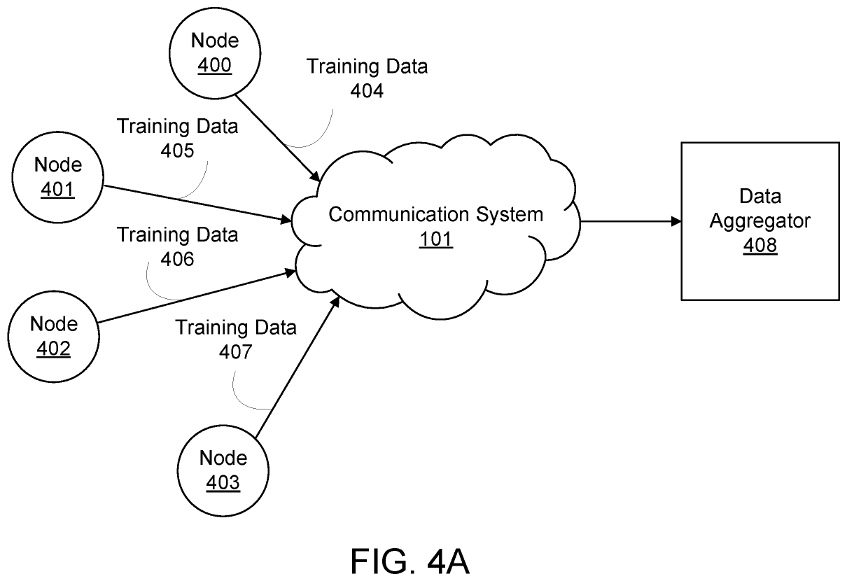

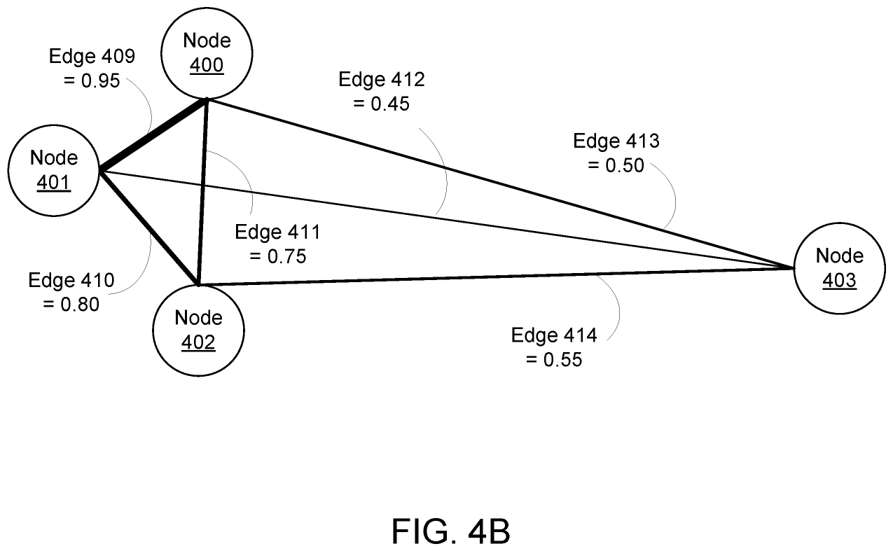

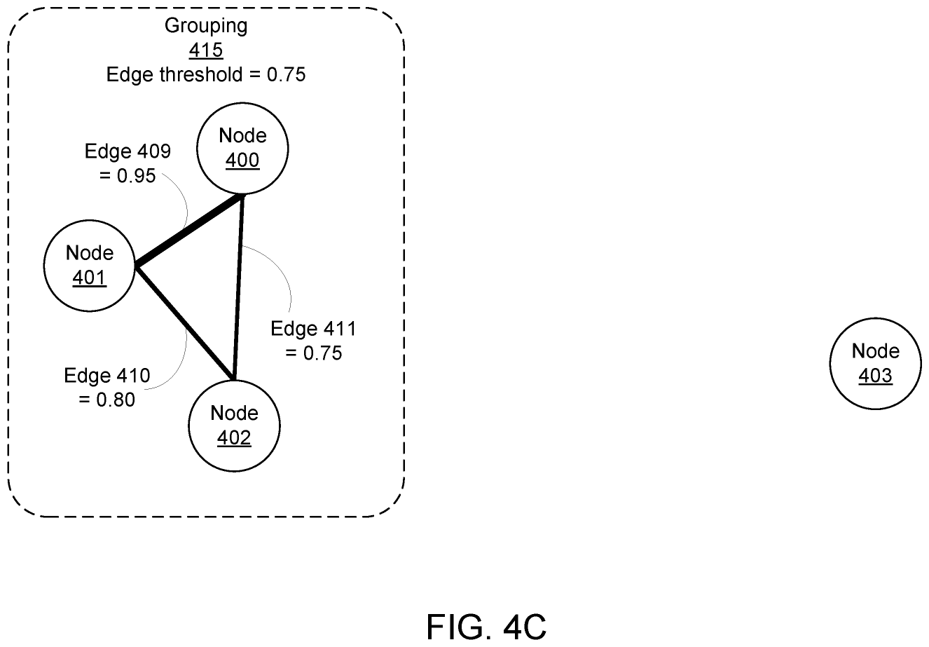

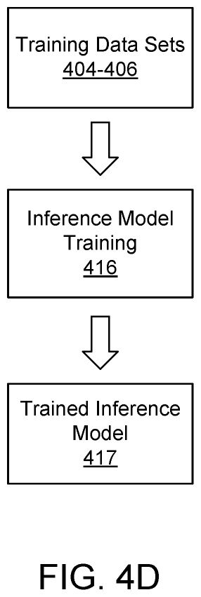

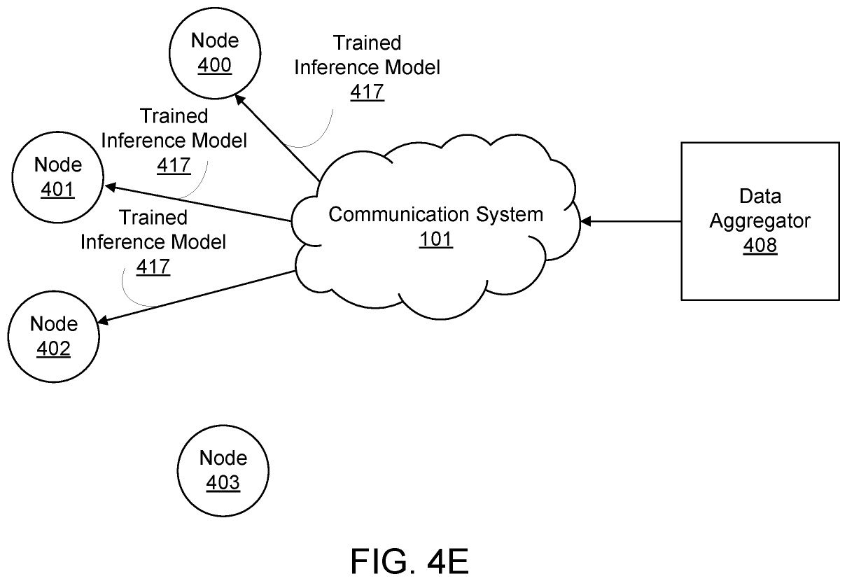

In an embodiment, similarity graphs 204 may include any number of similarity graphs based on training data obtained from sources (e.g., data collectors) throughout a distributed environment. Similarity graphs may include one node for each source and weighted edges between the nodes. Each edge between nodes may represent a similarity measure between nodes and each edge may be weighted to represent the similarity between the nodes. Edges may be obtained by performing an operation on the training data sets from each node to determine the similarity measure. Operations to determine the similarity measure may include performing a kernel method to determine clusters of nodes, determining cosine similarity between nodes, determining Euclidian distance between nodes, determining Pearson coefficient (and/or other correlation functions) between nodes, or determining similarity of an aggregated statistic associated with each node. Methods of determining similarity measures may include other types of methods without departing from embodiments disclosed herein. A portion of edges may be discarded if they are determined to fall below a threshold for similarity. Refer to operations 301-303 in FIG. 3A for additional details regarding obtaining similarity graphs. Refer to FIG. 4B for an example of a similarity graph. Edges may be used to determine groupings of nodes as described below.

In an embodiment, groupings 205 may include one or more groupings obtained from similarity graphs from similarity graphs 204. Groupings may be groupings of nodes with edges above a threshold, edges above a threshold indicating similarity between the data collected by the nodes in the grouping. Refer to operation 304 in FIG. 3A for additional details regarding the grouping of nodes. By grouping nodes, data aggregator 102 may generalize inference models to facilitate data collection across a grouping and, therefore, host and operate fewer inference models overall.

In an embodiment, inference model repository 206 may include one or more inference models. The inference models may be obtained by feeding training data 203 into a machine learning (e.g., a deep learning) model to predict data based on measurements performed by data collectors 100 (and/or other sources) without having access to the measurements. Inference models may be trained using training data sets obtained from one or more of data collectors 100. Data collectors in a grouping may utilize the same inference model to facilitate data collection, while data collectors in different groupings may utilize different inference models to facilitate data collection. Refer to FIG. 1 for additional details regarding the use of inference models for data collection.

In an embodiment, aggregated data repository 207 may include any amount of data obtained from data collectors (e.g., data collectors 100) and/or inferences obtained by data aggregator 102. For example, data aggregator 102 may obtain a portion or representation of data (e.g., a data statistic, difference between data and an inference intended to match the data, etc.) from data collectors 100. Data aggregator 102 may use the portion or representation of data to obtain aggregated data based on measurements performed by the data collectors. The aggregated data may be stored in aggregated data repository 207 (and/or other locations). Aggregated data may be obtained via other methods without departing from embodiments disclosed herein. Refer to FIG. 1 for additional details regarding methods of obtaining aggregated data.

While illustrated in FIG. 2 as including a limited number of specific components, a data aggregator in accordance with an embodiment may include fewer, additional, and/or different components than shown in FIG. 2.

As discussed above, the components of FIG. 1 may perform various methods to manage inference model distribution throughout a distributed environment. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of selecting inference models for groupings of data collectors in accordance with an embodiment is shown.

At operation 300, training data may be obtained from sources throughout a distributed environment. Training data sets may include any quantity and type of data. For example, training data sets may include a series of measurements representing an ambient environment (e.g., temperature data, humidity data, pH data).

In an embodiment, the training data sets may be obtained from any number of data collectors (e.g., data collectors 100) throughout a distributed environment. For example, requests for the training data sets may be sent to the data collectors and the data collectors may provide the training data sets to the data aggregator in response to the requests. Such messages and/or data may be passed via a communication system operably connecting the data collector and the data aggregator.

In an embodiment, the training data sets may be provided by another entity through a communication system. For example, the training data sets may be obtained by data collectors throughout a second distributed environment with a similar environment. These training data sets may be provided to any number of data aggregators in any number of distributed environments.

At operation 301, a similarity graph may be obtained, by creating a series of nodes and/or edges. A similarity graph may be a representation of nodes (e.g., data collectors) and the relationships between the nodes. The similarity graph may display one node for each data collector throughout the distributed environment.

In an embodiment, the similarity graph may be obtained by data aggregator 102 by feeding training data from each node into one or more similarity algorithms. The algorithm may establish a base graph data structure which may include representations of the respective nodes.

In a second scenario, data aggregator 102 may obtain the similarity graph from another entity through a communication system. For example, a similarity graph may be obtained by another entity by feeding training data into one or more similarity algorithms. In this scenario, the similarity graph obtained via another entity may or may not require updating by the data aggregator. Refer to FIG. 4B for an example of a similarity graph.

At operation 302, relationships may be determined between nodes on the similarity graph. Relationships between nodes may be represented by a similarity measure, a similarity measure being some representation of the similarity between data obtained by data collectors associated with each node. Similarity measures may be displayed on the similarity graph as weighted edges between nodes. An edge with a larger weight may indicate similarity between the data associated with the nodes, while a smaller weight may indicate dissimilarity between the data associated with the nodes.

In an embodiment, relationships between nodes on the similarity graph may be obtained by data aggregator 102 from the result of feeding training data into one or more similarity algorithms as described above. The similarity algorithms may provide scores or other representations of the relative similarity of the training data. The similarity between the training data may be used as a basis for the relationships between the nodes of the similarity graph. Refer to FIG. 2 for additional details regarding the determination of relationships between nodes.

At operation 303, some relationships may be discarded to obtain updated relationships on the similarity graph. Discarding relationships may entail any method of removing them from consideration (e.g., deleting them, ignoring them, etc.) In a first scenario, a relationship may be discarded if the weight of the edge falls below an established threshold (or a dynamically-determined threshold, or other type of metric). The threshold may be obtained from a user, from another entity through a communication system, or via other methods. In a second scenario, a relationship may be discarded in order to maintain a maximum and/or minimum number of nodes in a particular grouping. Relationships may be discarded for other reasons without departing from embodiments disclosed herein. Refer to FIG. 2 for more details regarding discarding relationships between nodes.

In an embodiment, similarity measures may be updated following operation 303 in order to obtain more accurate relationships between nodes. For example, data aggregator 102 may discard edges below a threshold and generate new relationships based on the retained edges. These new relationships may be more computationally-intensive and, therefore, more accurate. Data aggregator 102 may utilize updated relationships to form groupings of nodes as described below.

At operation 304, groupings of nodes may be determined based on the updated relationships between nodes on the similarity graph. Groupings may be established for one or more nodes with retained edges, the retained edges indicating similarity between the data collected by the nodes. As noted above, edges may be retained on the similarity graph if they fall above the established threshold, in order to maintain the number of nodes in a grouping, and/or for other reasons.

The groupings of the nodes may be determined, for example, by performing graph traversal or other methods for extracting relevant information from a graph data structure. Refer to FIG. 2 for additional details regarding establishing groupings of nodes. Refer to FIG. 4C for an example of a grouping of nodes.

At operation 305, one or more inference models may be obtained for each grouping. The one or more inference models may be implemented with, for example, machine learning models and/or other types of inference generation algorithms. The one or more inference models may generate inferences that predict future data obtained by data collectors within a grouping without having access to the data obtained by the data collectors within a grouping. Therefore, one inference model may be generalized to predict data from multiple grouped data collectors which are all likely to collect similar data. Accordingly, the inference model for the group may generally provide accurate predictions for the data obtained by the members of the group. Consequently, data aggregator 102 may host fewer inference models overall (when compared to a scenario in which a unique inference model is obtained for each data collector) and, therefore, consume fewer computing resources during operation.

In an embodiment, the one or more inference models may be obtained by the data aggregator using the training data sets associated with the data collectors in a grouping. The training data sets may be fed into a machine learning model (and/or other type of inference generation model) to obtain the one or more inference models to predict future measurements from data collectors within the grouping.

In an embodiment, the one or more inference models may also be obtained from another entity through a communication system. For example, one or more inference models may be obtained by another entity through training machine learning models and providing the trained machine learning models to the data aggregator. In this scenario, the one or more inference models obtained via another entity may or may not require training by the data aggregator.

At operation 306, trained inference models may be utilized for data collection. Trained inference models may facilitate data collection by data collectors within a grouping by predicting data based on measurements performed by the data collectors in the grouping. By doing so, not all of the data collected by data collectors may need to be transmitted to the data aggregator for the data aggregator to have access to the collected data. Refer to FIG. 1 for additional details regarding the use of inference models to facilitate data collection throughout a distributed environment.

Turning to FIG. 3B, a flow diagram illustrating a method of updating inference models for groupings of data collectors in accordance with an embodiment is shown.

At operation 307, trained inference models may be used for data collection throughout a distributed environment. Trained inference models may facilitate data collection by data collectors within a grouping by predicting data based on measurements performed by the data collectors in the grouping. Refer to FIG. 1 for additional details regarding the use of inference models to facilitate data collection throughout a distributed environment.

At operation 308, the similarity graph may be updated based on collected data by updating relationships between nodes. During data collection, the data associated with each node on the similarity graph may be updated continuously, intermittently, or on any other established schedule. Updating the data associated with each node on the similarity graph may update the relationships and, therefore, the weighting of edges between the nodes. For example, all or a portion of operations 302-303 may be performed to update the similarity graph.

At operation 309, it may be determined whether a grouping has changed on the similarity graph. The grouping may change if the weight associated with one or more edges changes enough to cross an established threshold (or dynamically-determined threshold, or other type of metric). The threshold may be obtained from a user, from another entity through a communication system, or via other methods.

In an embodiment, the grouping may also change if nodes are added to the similarity graph or removed from the similarity graph. This may occur in order to maintain a maximum and/or minimum number of nodes in each grouping. If the grouping of nodes has not changed, the method may proceed to operation 311. If the grouping of nodes has changed, the method may proceed to operation 310.

At operation 310, one or more inference models may be associated with the new groupings or one or more new inference models may be obtained. In a first scenario, the updated groupings may redistribute nodes among other groupings, and existing inference models may continue to be used. In this scenario, data aggregator 102 may identify the inference models associated with the updated groupings and utilize the inference models associated with the updated groupings to facilitate data collection from the data collectors associated with the respective groupings.

In a second scenario, the updated groupings leave one or more nodes outside of the established groupings. In this scenario, new groupings may be established for the one or more nodes, a new inference model for each of the new groupings may be obtained, and the new inference models may be utilized to facilitate data collection from the node.

In an embodiment, the evaluation of new groupings may be delayed until the number of outlier nodes reaches a threshold (and/or some other correlated statistic). Prior to this threshold being reached, the outlier nodes may utilize non-optimal inference models to facilitate data collection. By doing so, computational resources may be conserved and new groupings of nodes may be established only upon identification of a sufficient number of outlier nodes.

At operation 311, data collection may be performed using the one or more inference models associated with the groupings of nodes. Refer to FIG. 1 for additional details regarding the use of inference models to facilitate data collection.

The method may end following operation 311.

Turning to FIGS. 4A-4E, these figures may illustrate a system similar to that of FIG. 1 and/or similarity graphs in accordance with an embodiment. FIGS. 4A-4E may show actions performed by the system over time and/or modifications made to a similarity graph. The system may include node 400, node 401, node 402, node 403, and data aggregator 408. Nodes 400-403 may be operably connected to data aggregator 408 via communication system 101. In order to aggregate data from multiple sources (e.g., nodes 400-403) throughout a distributed environment, data aggregator 408 may host and operate one or more inference models. Consequently, it may be desirable to limit the quantity of inference models hosted and operated by data aggregator 408 in order to reduce computational overhead and minimize transmissions over communication system 101 for purposes of training inference models, re-training inference models, and/or distributing inference models to nodes 400-403.

For example, data aggregator 408 may include limited computing resources or may be performing heavy workloads that utilize the aggregated data which limit the performance of other workloads, such as inference model training and/or operating trained inference models.

Turning to FIG. 4A, consider a scenario where nodes 400-403 obtain training data sets 404-407. Training data sets 404-407 may include any type and/or range of data and may be collected over any range of time. Training data sets 404-407 may contain similar or dissimilar data. For example, node 400 may be a temperature sensor and training data set 404 may include the following temperature measurements collected over the course of one hour: T₁=25.5° C., T₂=25.0° C., T₃=25.5° C., T₄=25.0° C., T₅=24.5.0° C. In contrast, node 403 may be a temperature sensor and training data set 407 may include the following temperature measurements collected over the course of one hour: T₁=−0.5° C., T₂=−1.0° C., T₃=−0.8° C., T₄=−0.9° C., T₅=−0.5° C. Data aggregator 408 may obtain training data sets 404-407 for the purpose of obtaining a similarity graph, groupings of nodes, and/or training inference models to predict future temperature measurements obtained by nodes 400-403.

Data aggregator 408 may obtain a similarity graph by feeding training data sets 400-407 into one or more similarity algorithms. The one or more similarity algorithms may establish a base graph data structure which may include representations of nodes 400-403. Turning to FIG. 4B, a similarity graph is illustrated representing nodes 400-403 and the relationships between nodes 400-403. The relationships between nodes 400-403 may be represented by edges 409-414. Edges 409-414 may represent a similarity measure between nodes, a similarity measure being some representation of the similarity between data obtained by the temperature sensors associated with each node. For example, edge 409 may represent the similarity between node 400 and node 401. Each of edges 409-414 may be weighted to represent the degree of similarity between two nodes as described below.

Edges 409-414 may have an associated weight, the weight represented on the similarity graph by the thickness of the connecting lines. An edge with a larger weight (e.g., a thicker line) may indicate a higher degree of similarity between data collected by two nodes, while a smaller weight (e.g., a thinner line) may indicate a lower degree of similarity between data collected by two nodes. The weighted edges may be obtained by data aggregator 408 as a result of feeding training data sets 404-407 into one or more similarity algorithms as described above. The one or more similarity algorithms may provide scores or other representations of the relative similarity of the training data. The weights may be represented by a score between 0-1, with 0 indicating a low degree of similarity and 1 indicating a high degree of similarity. For example, edge 409 may have a weight of 0.95 on a scale of 0-1, while edge 412 may have a weight of 0.45 on a scale of 0-1. This may indicate a high degree of similarity between data obtained by node 400 and data obtained by node 401, and a low degree of similarity between data obtained by node 401 and data obtained by node 403. Some relationships may be discarded in order to obtain groupings of nodes as described below.

Some relationships (e.g., edges) may be discarded in order to obtain groupings of nodes, groupings of nodes indicating nodes that may obtain similar data. Turning to FIG. 4C, edges may be discarded if the weight of the edge falls below a threshold. In this example, the threshold may be a weight of 0.75. Therefore, edge 409, edge 410, and edge 411 may be retained, while edge 412, edge 413, and edge 414 may be discarded. By discarding edges 412-414, grouping 415 may be established to include nodes 400-402. Grouping 415 and the threshold may be obtained by performing graph traversal or other methods of extracting relevant information from the graph data structure. Grouping 415 may indicate similarity between the data obtained by nodes 400-402 and data aggregator 408 may train inference models based on data obtained by groupings of nodes rather than individual nodes as described below.

Turning to FIG. 4D, data aggregator 408 may train one inference model to facilitate data collection by the nodes associated with grouping 415. By doing so, data aggregator 408 may be able to generalize inference models for groups of nodes collecting similar data and, therefore, utilize fewer computing resources during operation. Data aggregator 408 may utilize training data sets 404-406 from nodes 400-402 to perform an inference model training 416 process to obtain a trained inference model 417. Refer to operation 305 in FIG. 3A for additional details regarding the training of inference models.

Additional groupings may be established on the similarity graph (not shown) and, therefore, additional inference models may be trained to predict data based on the nodes in the additional groupings. In a first scenario, node 403 may establish edges with additional nodes not shown on the similarity graph. Node 403 may be incorporated into a grouping if the established edges fall above the threshold (and/or for other reasons). In a second scenario, data collected by node 403 may not result in any relationships to other nodes with edges above the threshold when fed into one or more similarity algorithms. In this scenario, data aggregator 408 may train an inference model (not shown) based on training data set 407.

Turning to FIG. 4E, data aggregator 408 may distribute trained inference model 417 to nodes 400-402 to facilitate data collection by nodes 400-402. Trained inference model 417 may be trained to predict data based on measurements performed by nodes 400-402 and, therefore, trained inference model 417 may be utilized in order to reduce data transmissions over communication system 101 during data collection. Refer to FIG. 1 for additional details regarding the use of inference models for data collection. As mentioned above, data aggregator 408 may distribute a second trained inference model (not shown) to node 403 and/or other nodes. In some scenarios, trained inference model 417 (and/or others) may be hosted and operated by data aggregator 408 and may not be distributed to nodes 400-402. Data aggregator 408 may utilize trained inference model 417 (and/or others) to facilitate data collection throughout the distributed environment via other methods without departing from embodiments disclosed herein.

By establishing groupings of nodes and generalizing the trained inference models, the computing resources necessary to host and operate inference models by data aggregator 408 may be reduced. In addition, hosting and operating fewer inference models throughout the distributed environment may result in reduced network transmissions during training and re-training of inference models. Consequently, network bandwidth may be conserved over communication system 101 and power consumption by data aggregator 408 and/or nodes 400-403 may be reduced.

Any of the components illustrated in FIGS. 1-4E may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing data collection in a distributed environment where data is collected in a data aggregator of the distributed environment and from sources operably connected to the data aggregator via a communication system, comprising:
obtaining, by the data aggregator, a similarity graph, the similarity graph comprising:
nodes based on data collected from the sources throughout the distributed environment and representing the sources, and
a relationship between a portion of the nodes, the relationship being implemented with an edge connecting a portion of the nodes;
determining, by the data aggregator, groupings of the nodes based on the similarity between the nodes;
obtaining, by the data aggregator, an inference model for each of the groupings;
collecting data from the sources utilizing the inference models, the inference models being used to reduce a quantity of data transmitted for the data collection.

2. The method of claim 1, further comprising:
making a determination that the relationship between the nodes falls below a threshold; and
based on the determination:
discarding the edge.

3. The method of claim 2, wherein discarding the edge indicates that the portion of the nodes collect dissimilar data.

4. The method of claim 1, further comprising:
making a determination that the relationship between the nodes is within a threshold; and
based on the determination:
retaining the edge between the portion of the nodes.

5. The method of claim 4, wherein retaining the edge indicates that the portion of the nodes collect similar data.

6. The method of claim 1, further comprising:
updating, by the data aggregator, the similarity graph based on the collected data by updating the relationship based on a change in the similarity between the nodes.

7. The method of claim 6, further comprising:
making a determination, based on the updated relationship, that the groupings of the nodes has changed; and
based on that determination:
selecting an inference model for each of the groupings based on the changed groupings, or
obtaining a new inference model for at least one of the groupings using a portion of the collected data associated with the respective grouping.

8. The method of claim 6, further comprising:
making a determination, based on the updated relationship, that the grouping of nodes has not changed; and
based on that determination:
continuing the data collection from the sources utilizing the inference models.

9. The method of claim 1, wherein collecting data from the sources utilizing the inference models comprises:
for a portion of the sources that are members of a group of the groups, use an inference model of the inference models associated with the group to collect the portion of the data from the portion of the sources.

10. The method of claim 1, wherein the similarity between any two nodes of the nodes is based on a similarity measure of data collected by the sources associated with the two nodes and the method of determining the similarity measure comprises one selected from a group consisting of determining cosine similarity between nodes, performing a kernel method to determine clusters of nodes, and determining similarity of an aggregated statistic associated with the nodes.

11. A non-transitory machine-readable medium having instructions stored therein, which when executed by a processor, cause the processor to perform operations for managing data collection in a distributed environment where data is collected in a data aggregator of the distributed environment and from sources operably connected to the data aggregator via a communication system, the operations comprising:
obtaining, by the data aggregator, a similarity graph, the similarity graph comprising:
nodes based on data collected from the sources throughout the distributed environment and representing the sources, and
a relationship between a portion of the nodes, the relationship being implemented with an edge connecting a portion of the nodes;
determining, by the data aggregator, groupings of the nodes based on the similarity between the nodes;
obtaining, by the data aggregator, an inference model for each of the groupings;
collecting data from the sources utilizing the inference models, the inference models being used to reduce a quantity of data transmitted for the data collection.

12. The non-transitory machine-readable medium of claim 11, further comprising:
making a determination that the relationship between the nodes falls below a threshold; and
based on the determination:
discarding the edge.

13. The non-transitory machine-readable medium of claim 12, wherein discarding the edge indicates that the portion of the nodes collect dissimilar data.

14. The non-transitory machine-readable medium of claim 11, further comprising:
making a determination that the relationship between the nodes is within a threshold; and
based on the determination:
retaining the edge between the portion of the nodes.

15. The non-transitory machine-readable medium of claim 14, wherein retaining the edge indicates that the portion of the nodes collect similar data.

16. A data aggregator for managing data collection in a distributed environment where data is collected in the data aggregator of the distributed environment and from sources operably connected to the data aggregator via a communication system, comprising:
a processor; and
a memory coupled to the processor to store instructions, which when executed by the processor, cause the processor to perform operations for managing the data collection, the operations comprising:
obtaining, by the data aggregator, a similarity graph, the similarity graph comprising:
nodes based on data collected from the sources throughout the distributed environment and representing the sources, and
a relationship between a portion of the nodes, the relationship being implemented with an edge connecting a portion of the nodes;
determining, by the data aggregator, groupings of the nodes based on the similarity between the nodes;
obtaining, by the data aggregator, an inference model for each of the groupings;
collecting data from the sources utilizing the inference models, the inference models being used to reduce a quantity of data transmitted for the data collection.

17. The data aggregator of claim 16, further comprising:
making a determination that the relationship between the nodes falls below a threshold; and
based on the determination:
discarding the edge.

18. The data aggregator of claim 17, wherein discarding the edge indicates that the portion of the nodes collect dissimilar data.

19. The data aggregator of claim 16, further comprising:
making a determination that the relationship between the nodes is within a threshold; and
based on the determination:
retaining the edge between the portion of the nodes.

20. The data aggregator of claim 19, wherein retaining the edge indicates that the portion of the nodes collect similar data.
